(19) United States
(12) Patent Application Publication
(10) Pub. No.: US 2024/0046211 A1
(43) Pub. Date: Feb. 8, 2024

(54) Detecting Missing Objects with Reference RFID Tags

(71) Applicant: Automaton, Inc., San Diego, CA (US)

(72) Inventors: Spencer Hewett, New York, NY (US); Paul Petrus, San Jose, CA (US)

(73) Assignee: Automaton, Inc., San Diego, CA (US)

(21) Appl. No.: 18/490,570

(22) Filed: Oct. 19, 2023

Related U.S. Application Data
(63) Continuation of application No. PCT/US2022/026012, filed on Apr. 22, 2022.
(60) Provisional application No. 63/178,018, filed on Apr. 22, 2021.

(51) Int. Cl. G06Q 10/087; G01S 13/04

(52) U.S. Cl. CPC G06Q 10/087; G01S 13/04

(57) ABSTRACT

A radio-frequency identification (RFID) tag reader interrogates RFID tags and detects their replies. These replies may propagate along direct or line-of-sight paths from the tags to the reader. They may also propagate along indirect or non-light-of-sight paths from the tags to the reader, e.g., by reflecting off nearby objects to the reader. As a result, the reader receives many copies of each tag's reply, with each copy arriving at a delay and angle corresponding to the path that it followed from the tag to the reader. The aggregate or combination of the detected replies is called a multipath profile or signature. Each tag/reader pair produces its own multipath profile. Moving objects near the reader and tag can change that multipath signature by introducing or removing reflections along a given path between the reader and tag. These changes can be used to determine that an object has moved, even if that object does not have an RFID tag.

### CROSS-REFERENCE TO RELATED APPLICATIONS

This application is a bypass continuation of International Application No. PCT/US2022/026012, Apr. 22, 2022, which in turn claims the priority benefit, under 35 U.S.C. 119(e), of U.S. Application No. 63/178,018, filed on Apr. 22, 2021, which is incorporated herein by reference in its entirety for all purposes.

### BACKGROUND

A radio-frequency identification (RFID) tag is a small transponder that is usually pre-programmed to emit a unique identification signal in response to a query or interrogation signal from an RFID tag reader. A passive RFID tag includes a microchip with a small memory and a coil or antenna that is powered by the interrogation signal itself. The interrogation signal usually includes a continuous-wave (cw) tone that charges microchip via the coil or antenna. The coil or antenna backscatters a version of the cw tone modulated according to the information, such as a unique identifier, stored in the memory.

RFID tags are used to identify and track objects in warehouses, stores, and other environments. They are inexpensive and easy to manufacture; for example, the microchip and antenna can be printed on a piece of paper with an adhesive backing that sticks onto an item. In a clothing store, for example, there may be a passive RFID tag on the price tag of each article of clothing for sale inside the store. A database stores each RFID tag's unique identifier associated with information about the article of clothing that the RFID tag is attached to. By querying the RFID tags with one or more readers dispersed throughout the store, a manager can determine and track the store inventory. The system may even be able to locate the tagged item within a certain part of the store by sensing the power levels and/or angles of arrival of the tag's response with RFID readers at different positions within the store. Readers at the checkout or exit can be used to track items as they leave the store, e.g., for automatic checkout or loss prevention. Similarly, readers in the stockroom can be used to track items as they arrive at the store and are placed on the sales floor.

One challenge with using RFID technology in stores, warehouses, and other environments with many surfaces is the that the response from each tag propagates along many different paths at the same time from the tag to the reader. This phenomenon is known as multipath propagation and can result in interference that produces fading, ghosting, and/or other undesired effects that complicate efforts to estimate the tag's location from the energy received by the reader. For example, a tag may respond to a query from a reader by backscattering equal or near-equal amounts of radio-frequency (RF) energy in many directions at once. A portion of this RF energy propagates along a direct or line-of-sight (LOS) path from the tag to the reader. Some or all of the remaining RF energy may propagate along indirect or non-line-of-sight (NLOS) paths from the tag to the reader; that is, some or all of the remaining RF energy may reflect or scatter off one or more surfaces as it propagates from the tag to the reader. The radiation propagating along these different paths may interfere, causing fading or ghost to appear in the signal received by the reader.

### SUMMARY

In addition to detecting the presence and locations of items with RFID tags, RFID tag systems can also be used to detect the presence or absence of an item without an RFID tag. This item may be for sale on a shelf, display rack, or garment rack. More specifically, one or more RFID tag readers may detect a multipath signature of an RFID tag mounted on or near the shelf, display rack, or garment rack. This multipath signature represents reflection, scattering, and/or attenuation, by the item, of radiation backscattered from the RFID tag in response to a signal from the reader. If a customer or other person removes the item from the shelf, display rack, or garment rack, this will produce a change in the multipath signature of the RFID tag that can be detected by the reader(s). A processor or controller coupled to the reader(s) determines that the item has been removed from the shelf, display rack, or garment rack based on this change in the multipath signature of the RFID tag.

Detecting the multipath signature may include detecting, by the reader, the radiation backscattered from the RFID tag along at least one NLOS path from the RFID tag and the reader. In these cases, detecting the change in the multipath signature of the RFID tag may include sensing a change in a power propagating along the NLOS path(s) from the RFID tag and the reader. The item may be replaced in response to determining that the item has been removed from the shelf, display rack, or garment rack.

More generally, RFID systems can be used to detect movement of an object from its nominal location. A reader detects a multipath signature of an RFID tag mounted on a fixed or stationary object near the nominal location of the object. This multipath signature represents reflection, scattering, and/or attenuation, by the object, of radiation backscattered from the RFID tag in response to an interrogation signal. If the object moves with respect to the fixed or stationary RFID tag, causing a change in the RFID tag's multipath signature. This change can be used to determine that the object has moved from its nominal position.

Other inventive methods of detecting movement of an item (e.g., without an operative RFID tag) on a shelf, bin, display rack, or garment rack include detecting a signal from an RFID tag mounted on or near the shelf, bin, display rack, or garment rack, e.g., with an antenna array in an RFID tag reader. The reader compares the signal to a previously recorded baseline signal from the RFID tag and determines that the item has moved based on the comparison. The reader can perform the comparison by calculating an error metric (e.g., the (squared) Euclidean distance) between a vector representation of the signal and a vector representation of the previously recorded baseline signal. If the error metric exceeds a predetermined threshold, possibly for at least a predetermined duration, then the reader determines that the item have moved. In some cases, the error metric is a first error metric and the baseline signal is a first baseline signal representing a first condition of the item, in which case the reader can calculating a second error metric between the vector representation of the signal and a vector representation of a second baseline signal representing a second condition of the item. If the first error metric is smaller than the second error metric, then the reader can determine that the item is more likely to be in the first condition than the second condition. In response to determining that the item has moved, the reader can trigger re-stocking of the item.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows line-of-sight (LOS) and non-line-of-sight (NLOS) paths between stationary RFID tags and the first of two (stationary) readers with a movable object blocking some NLOS paths and affecting the multipath signatures or profiles of the RFID tags at the first reader.

FIG. 1B is a plot showing the multipath signatures or profiles of the RFID tags as measured by the first reader in the environment of FIG. 1A.

FIG. 1C shows the environment of FIG. 1A after the one of the movable objects has been removed, unblocking the NLOS paths between the RFID tags and the first reader.

FIG. 1D is a plot showing the multipath signatures of the RFID tags as measured by the first reader in the environment of FIG. 1C, after the object has been removed.

FIG. 2A shows the LOS and NLOS paths between the RFID tags and the second reader with a movable object blocking some of the LOS paths and affecting the multipath signatures of the RFID tags at the second reader.

FIG. 2B is a plot showing the multipath signatures of the RFID tags as measured by the second reader in the environment of FIG. 2A.

FIG. 2C shows the environment of FIG. 2A after the one of the movable objects has been removed, unblocking the LOS paths between the RFID tags and the second reader.

FIG. 2D is a plot showing the multipath signatures of the RFID tags as measured by the second reader in the environment of FIG. 2C, after the object has been removed.

FIG. 3 illustrates a process for detecting whether an item without an operative RFID tag has moved based on changes in signatures of nearby RFID tags.

FIG. 4A illustrates changes in the vector representation(s) of replies from an RFID tag over time caused by movement of nearby objects.

FIG. 4B illustrates a process for detecting whether an item without an operative RFID tag has moved based on changes in the vector representation(s) of signals from one or more nearby RFID tags.

### DETAILED DESCRIPTION

Changing multipath signatures can be used to determine if an item with or without an RFID tag (or with an inoperative RFID tag) has moved within or out of an environment. The environment could be a store, warehouse, or other facility at least partially bounded by walls and may contain shelves, garment racks, furniture, cash registers, interior walls, and/or other objects that are fixed, immobile, or at least not moved often. RFID tags, or simply tags, are mounted or fixed to the shelves and/or possibly fixed to other objects in the environment, including other stationary or largely immobile objects. These RFID tags are monitored by one or more readers, which may be mounted on the ceiling or wall at known positions.

In operation, the readers interrogate the RFID tags by broadcasting queries and/or other interrogation signals. The RFID tags respond to these queries by backscattering modulated radiation, with the modulation representing the tags' responses to the queries. Some of this modulated radiation propagates in a straight line from the tag to the reader without encountering any obstacles. This radiation is said to follow a line-of-sight (LOS) path from the tag to the reader. And some of this modulated radiation may be scattered or reflected off the shelves, walls, and/or other objects in the room before being detected by one or more of the readers, producing a unique multipath signature for each tag at each reader. Radiation that is scattered or reflected en route from the tag to the reader is said to follow a non-line-of-sight (NLOS) path from the tag to the reader. A reader that detects or senses radiation from a tag via both LOS and NLOS paths collects a multipath signature or profile for that tag as explained in greater detail below, with peaks representing the time delays and/or directions associated with the respective LOS and NLOS paths.

Changing the position, orientation, and/or location of an object can change the multipath signature of a nearby tag. For example, consider a tag that is on a shelf (e.g., fixed to the shelf or on an object sitting on the shelf). An item on the shelf scatters and/or reflects the tag's replies to a nearby reader, creating a multipath profile including at least one peak for the scattered radiation for that tag sensed by that reader. Removing the item from the shelf changes the multipath signature of tag as detected at reader. With the item no longer in the way, backscattered radiation from the tag no longer reflects or scatters off the item to the reader, causing the peak or feature in the multipath signature to change shape or disappear. The presence, absence, or shape of the peak indicates whether or not an item is near the tag and that the item may need to be replaced or moved. As a result, the appearance of the tag's multipath profile can trigger re-stocking or replacement of one or more items on the shelf.

Each RFID tag in a multipath environment may have a unique multipath signature. These unique multipath signatures or profiles vary based on the RFID tags' locations, the locations of the readers that detect the responses from the RFID tags, and the locations of walls, shelves, furniture, and other objects in the environment. For instance, a reader that is mounted directly above a given RFID tag may sense a multipath signature that is dominated by power traveling along an LOS path, whereas a reader mounted across the room from the RFID tag may sense a multipath signature with power collected from each of several NLOS. Each tag/reader multipath signature combination depends on the relative positions of the tag, reader, and other objects in the environment, including walls, furniture, people, and vehicles.

Changing the location an object of an environment can change the multipath signature of an RFID tag as sensed by the reader(s) that monitor the environment even if the RFID tag and reader(s) have not moved. These changes can be used to determine whether an object has been moved within or removed from the environment. In some cases, moving the object affects the multipath profiles of RFID tags at different locations. These changes can be used to infer which object has moved, the object's former location, and possibly the object's new location.

The ability to detect that an untagged object has moved can be especially useful when tracking items without RFID tags, e.g., in a store, stockroom, warehouse, logistics center, shipping facility, hospital, or other environment where not every item may be tagged with an RFID tag. In a grocery store, for example, changes in multipath signatures can be used to determine if a produce shelf or bin is empty and should be re-stocked. In a clothing store, changes in multipath signatures could indicate that a shelf or garment rack is partially or completely empty and should be re-stocked. They can also be used to determine if a person or cart is blocking an aisle, doorway, or other space. Or they can be used to sense that clothes or other items have been left in a changing room or other space and should be returned the sales floor.

Multipath Profiles

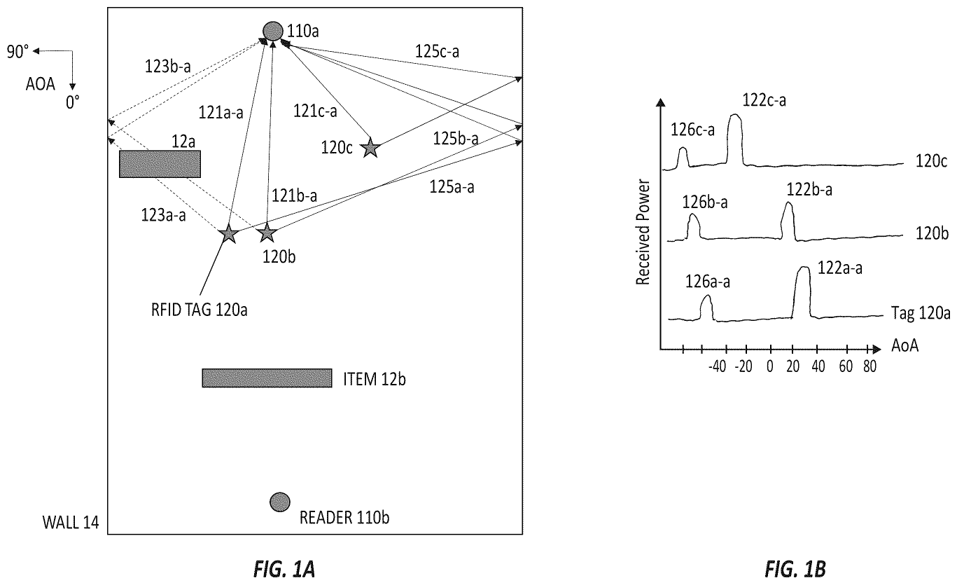

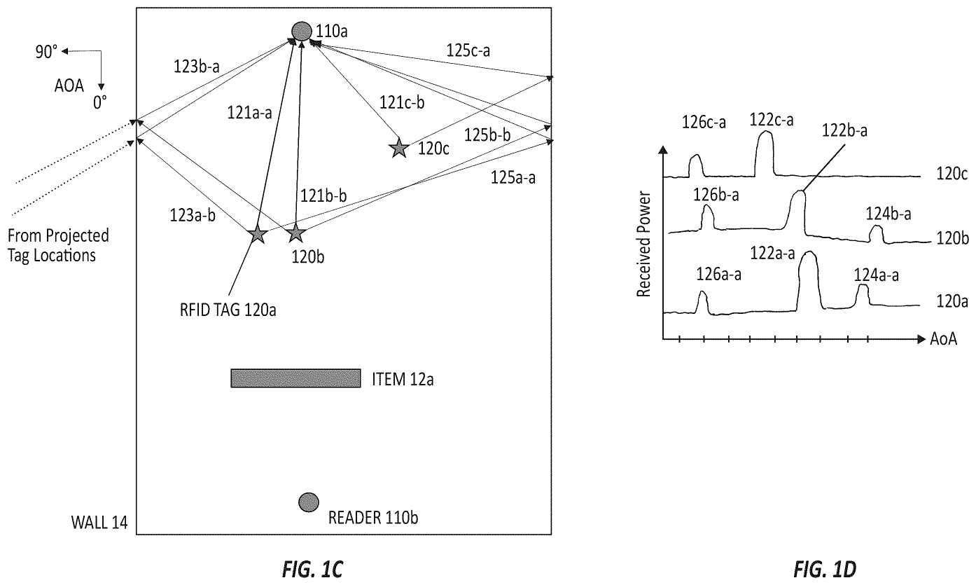

FIGS. 1A and 1B illustrate how different RFID tags produce different multipath signatures. FIG. 1A shows an environment, such as a room in a warehouse, stockroom, or sales floor that contains one or more RFID tag readers 110a and 110b and one or more passive RFID tags 120a-120c. The RFID tag readers 110 are stationary and may fixed or mounted on the ceiling, wall 14, or another fixture, such as shelving or a piece of furniture. Each reader 110 is a positioned to transmit and receive RFID signals, e.g., in a frequency band from 860-960 MHz, throughout at least a portion of the environment.

The RFID tags 120 are also stationary and can be fixed in place. For instance, the RFID tags 120 can be mounted in or on shelving, baskets, coatracks, or other furniture at known locations. RFID tags 120 fixed at known locations are sometimes called reference tags and can be used for measuring relative and/or absolute positions of RFID tags 120 at unknown positions. The RFID tags 120 do not have to be fixed in place or at known locations; for instance, they can simply remain stationary for long enough to be considered “fixed” over the scale of the measurement, e.g., one minute, one hour, several hours, one day, several days, or longer. Whether an RFID tag is stationary can be determined by measuring the RFID tag's location with a reader 110 several times over an extended period. RFID tags 120 that remain stationary for long enough, even at unknown absolute locations, can be designated as virtual reference tags. For more on virtual reference tags and on measuring RFID tag locations using reference tags and virtual reference tags, please see U.S. Pat. No. 11,215,691, which is incorporated herein by reference in its entirety for all purposes.

In operation, the readers 110 query or interrogate the RFID tags 120 in turn. The first reader 110a interrogates the RFID tags 120 by broadcasting a radio-frequency (RF) signal that is detected by the RFID tags 120 within range. The RF signal may command one or more of the RFID tags 120 to respond to the first reader 110a. Each RFID tag 120 responds in turn by modulating and back-scattering the query signal to the first reader 110a. For example, the first RFID tag 120a may respond to a first query from the first reader 110a, the second RFID tag 120b may respond to a second query from the first reader 110a after the first reader 110a has received the replies from the first RFID tag 120a, and so on. The RFID tags 120 usually have dipole antennas, so the amplitude of the back-scattered tag reply depends in part on orientation of the dipole antenna with respect to the first reader 110a. The amplitude of the tag reply also depends on the distance or range between the first reader 110a and the tag 120 as well as on the presence of any obstructions or scatterers between the first reader 110a and the tag 120.

In a multipath environment like the one shown in FIG. 1A, the replies can take multiple paths from the tags 120 to the first reader 110a, depending on their positions relative to the first reader 110a and on the presence of other objects in the environment. The direct path from a tag 120 to a reader 110 is called the line-of-sight (LOS) path; the tag reply does not reflect or scatter as it propagates along the LOS path. An indirect path from a tag 120 to a reader 110 is called a non-line-of-sight (NLOS) path. A tag's reply scatters or reflects off at least one surface as it propagates along an NLOS path from a tag 120 to a reader 110. There is only one LOS path between a given tag 120 and a given reader 110, but there can be many NLOS paths between a given tag 120 and a given reader 120.

FIG. 1A illustrates LOS paths 121 and some NLOS paths 123 and 125 between the tags 120 and the first reader 110a. In this case, an object 12a between the tags 120 and the first reader 110a blocks some of the NLOS paths 123. As a result, the first reader 110a does not detect tag replies along these NLOS paths 123. Nevertheless, the first reader 110a detects tag replies propagating along NLOS paths 125a-a, 125b-a, and 125c-a from the tags 120a, 120b, and 120c, respectively, to the first reader 110a via a reflection off a section of wall 14 at right in FIG. 1A. The first reader 110a also detects tag replies propagating along LOS paths 121a-a, 121b-a, and 121c-a from tags 120a, 120b, and 120c, respectively, to the first reader 110a. Neglecting distortion and attenuation due to differences among the paths, the tag replies travelling along the different paths are identical but arrive at the first reader 110a from different angles and at different time delays due to the propagation along the different paths.

Each RFID tag 120 has its own multipath profile or signature at each reader 110. In FIG. 1A, the multipath profiles of each RFID tag 120 as sensed by the first reader 110a can be characterized as the collection of the replies traveling along distinguishable paths from that RFID tag to the first reader 110a. These paths can be distinguished based on the different delays or angles of arrival (AOAs) of the received copies of the reply.

Each reader 110 (including the first reader 110a) includes a phased array that can measure the incident power as a function of AOA. A phased array includes several antenna elements (e.g., four, six, nine, or more antenna elements) arranged in a one-dimensional (1D) or two-dimensional (2D) array as understood by those of skill in the art and disclosed in greater detail in U.S. Application No. 63/290,326, which is incorporated herein by reference in its entirety for all purposes. The phased array can form a narrow beam that can be scanned in 1D for a 1D phased array or 2D (e.g., azimuth and elevation) for a 2D phased array. When the phased array steers its beam to a particular direction or AOA, it filters out power arriving from other AOAs. (The power arriving at each AOA can also be detected with a single moving antenna element instead of a phased array.) By measuring the power at each AOA, it is possible to estimate the AOAs or directions along which the tag replies arrive at the first reader 110a from each tag 120.

FIG. 1B is a plot of the multipath profiles of the RFID tags 120 sensed by the first reader 110a. Each trace represents the power received by the first reader 110a as a function of AOA or scan direction. Put differently, each multipath profile can be thought of as an angular power spectrum. The traces are offset vertically from each other for clarity. The peaks 122 and 126 correspond to the LOS paths 121 and NLOS paths 125, respectively, in FIG. 1A. In practice, each multipath profile may include more peaks corresponding to other NLOS paths (not shown) from the corresponding tag 120 to the phased array in the first reader 110a. The multipath profiles can be used to determine the relative positions of the tags 120; the closer the tags 120 are to each other, the more similar their multipath profiles. If the multipath profiles are represented as vectors (e.g., amplitude as a function of AOA), their degrees of similarity can be quantified in terms of the Euclidean distances between corresponding points. Dynamic warping or similar approaches can be used to estimate the distances between tags 120 from the multipath profiles.

Changes in Multipath Profiles Caused by Object Movement

FIGS. 1C and 1D illustrate how changes in the multipath profiles can be used to detect motion of objects in the environment. Moving a tag 120 with respect to a reader 110 generally changes the tag's multipath profile as sensed by that reader 110 by changing the LOS path and the NLOS paths between the tag 120 and the reader 110. Moving an object near the tag 120 and the reader 110 does not change the relative positions of the tag 120 or the reader 110, but it can change the tag's multipath profile as sensed by the reader 110 by creating, altering, or removing an LOS or NLOS path between the tag 120 and the reader 110.

In FIG. 1A, for example, an object 12a, such as a piece of furniture, blocks the NLOS paths 121 between tags 120a and 120b and the first reader 110a. In FIG. 1C, the object 12a has been removed, allowing replies propagating along the NLOS paths 123a-a and 123b-a from the tags 120a and 120b, respectively, to the first reader 110a. This produces new peaks 124 in the multipath profiles at AOAs of near −30°. Because these peaks 124 correspond to NLOS paths 123 rather than LOS paths, they tend to be shorter and broader than the peaks 122 corresponding to the LOS paths 121.

Since the LOS paths 121 between the first reader 110a and the tags 120 is unobstructed whether or not the object 12a is present, the tags 120 should receive the first reader's signals without any undue distortion or attenuation and should re-radiate the same amount of power whether or not the object 12a is present. As a result, removing the object 12a does not change the amplitudes of the peaks for the LOS paths 121 or the NLOS paths 125. Instead, the only change in the multipath profiles caused by removing the object 12a is the appearance of the peaks 122 corresponding to the newly unobstructed NLOS paths 121.

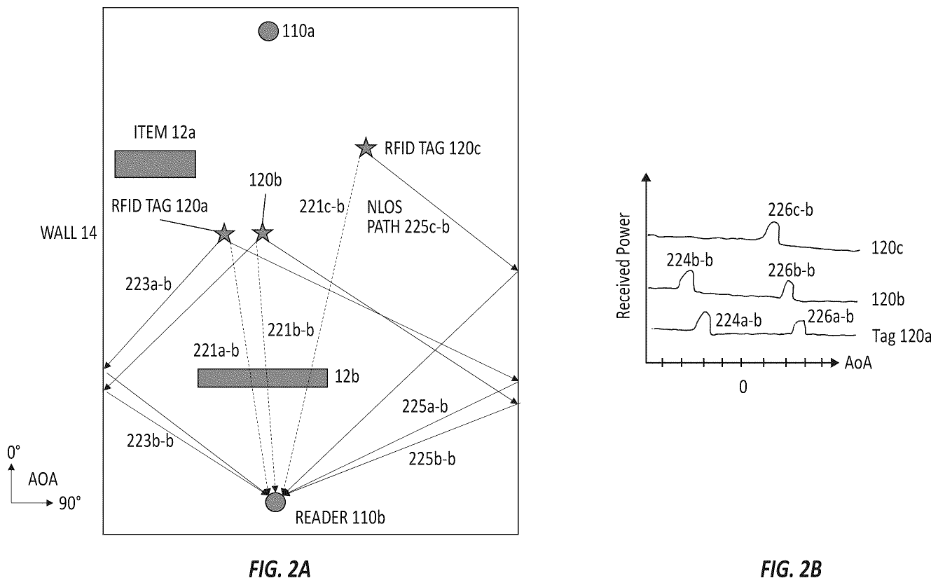

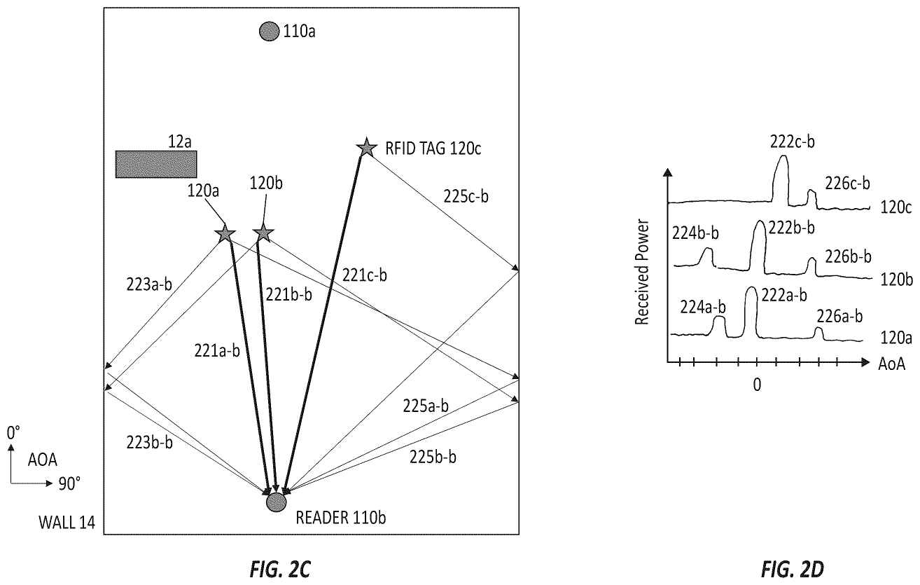

FIGS. 2A-2D illustrate a change in multipath profiles caused by movement an object 12b between the tags 120 and the second reader 110b. FIG. 2A shows that the object occludes the LOS paths 221a—c between the tags 120a-120c, respectively, and the second reader 110b. This prevents the tag replies propagating all the from the tags 120 to the second reader 110b. It may also attenuate queries or other signals emitted by the second reader 110b (in the worst case, the object 12b may prevent the queries from reaching the tags 120, at least at amplitudes high enough to trigger the tag replies). If the queries reach the tags 120 and trigger replies from them, those replies can propagate along NLOS paths 223 and 225 to the second reader 120, producing multipath profiles with corresponding peaks 224 and 226 as shown in FIG. 2B.

FIG. 2C shows that removing the object 12b from between the second reader 110b and the tags 120 allows signals to propagate along the LOS paths 221. This allows more radiation from the second reader 110b to reach the tags 120. It also allows the tag replies to reach the second reader 110b from different AOAs (the AOAs corresponding to the LOS paths 221). FIG. 2D shows that the resulting multipath profiles have additional peaks 222 corresponding to the LOS paths 221. The LOS peaks 222 are usually taller and sharper than the NLOS peak 224 and 226 because the LOS paths 221 are shorter and typically attenuate and distort the tag replies less than the NLOS paths 223 and 225. The presence of these peaks 222 indicates that an object (the object 12b) has been moved or removed.

The drawings in FIGS. 1A-1D and 2A-2D illustrate the effect of removing (untagged) objects on the multipath profiles of RFID tags. They also illustrate the effect of adding objects on the multipath profiles of RFID tags. To see how, simply consider the environments in FIGS. 1C and 2C as the initial conditions and the environments in FIGS. 1A and 2A as the later conditions. Adding objects in this order causes peaks to disappear from the RFID tags' multipath signatures. Adding and removing objects also illustrates now moving an object from one location to another can cause a peak at a first AOA to disappear and a peak at a second AOA to appear in the multipath signature.

In addition, adding, moving, or removing objects can affect multipath profiles as sensed by several readers. In FIGS. 1A-1D and 2A-2D, removing (or adding) the objects 12 affects either the multipath profiles sensed by the first reader 110a or the multipath profiles sensed by second reader 110b, but not both. However, adding, moving, or removing either or both objects 12 could affect the multipath profiles sensed by a reader positioned directly to the left of the tags 11 or at other points in the environment. Similarly, adding, moving, or removing an object from between tags 120b and 120c could affect the multipath profiles sensed by both readers 110. Other movement variations are possible and

Inferring Untagged Object Movement and Location from Changes in Multipath Profiles

Movement of untagged objects (and of the tags 120 themselves) can be inferred from comparisons of multipath profiles acquired at different times. Comparing the original and updated multipath profiles in FIGS. 1B and 1D, respectively, indicates that the reader 110a and tags 120 have not moved but that the environment has changed (because the object 12a has been removed). The original and updated multipath profiles include the same LOS peaks 122 and NLOS peaks 126, making it possible to infer that the corresponding LOS paths 121 and NLOS paths 125 are the same. Since these paths must intersect at both the reader 110a and the respective tags 120, they fix the positions of the reader 110a and the respective tags 120 (in 2D, in this example). The presence of the additional NLOS peaks 124 can be explained by the movement of an object (i.e., object 12a) that is not in the LOS paths 121.

Similarly, comparing the multipath profiles in FIGS. 2B and 2D shows that NLOS peaks 224 and 226 are in the same positions in both profiles, although perhaps higher in FIG. 2D, and that the LOS peaks 222 have appeared as a result of removing object 12b. Because the second object 12b is between the second reader 110b and the tags 120, removing it does not affect the tags' multipath profiles as sensed by the first reader 110a. Likewise, moving the first object 12a does not noticeably affects the tags' multipath profiles as sensed by the second reader 110b.

In contrast, if a tag moves, then its multipath profiles as sensed by different readers should change if the readers are fixed or stationary. For instance, consider what would happen if tag 120a moved along LOS path 221a-b toward the second reader 120b. The LOS peak 222 in the multipath profile sensed by the second reader 110b would still be centered at the same AOA, but the NLOS peaks 224 and 226 would shift apart in AOA. The multipath profile sensed by the first reader 110a for the tag 120a would also change, with every peak shifting in AOA.

Thus, if all of an RFID tag's multipath profiles change, then there is a strong likelihood that the tag has moved. If only one of an RFID tag's multipath profiles changes, though, or if only multipath profiles sensed by neighboring sensors have changed, then there is a strong likelihood that the tag has not moved but that another object near the tag has moved.

Changes in a single multipath profile can also indicate whether the tag has moved relative to the reader or if an object other than the tag has moved. If all of the peaks in a multipath profile have shifted position (AOA), then there is strong likelihood that the tag has moved relative to the reader. If only one peak has moved, appeared, or disappeared, then there is a strong likelihood that that tag has not moved, but another object near the tag has moved.

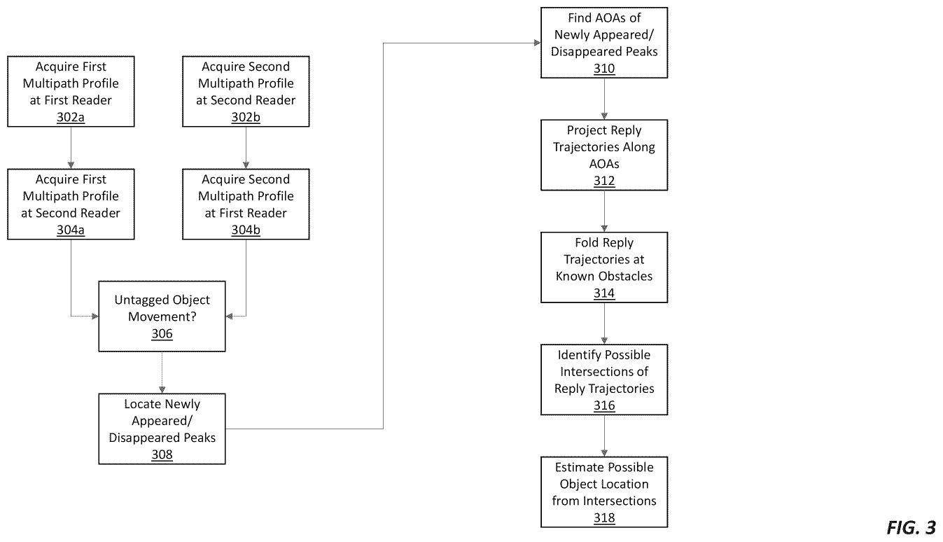

FIG. 3 illustrates how changes in the multipath profiles due to movement of untagged objects can be used to determine if an untagged object has moved and the object's location. To start, one or more RFID readers acquire multipath profiles of one or more tags (302a, 302b). Each RFID reader acquires several multipath profiles over time (304a, 304b), with at least one of these multipath profiles exhibiting the appearance or disappearance of at least one peak due to object movement as described above. Comparing the multipath profiles as described above indicates whether or not they have experienced any changes and, if so, whether those changes represent the movement of an untagged object as described above (306).

Using geometry, prior knowledge of the layout (e.g., the location of the wall 14 in FIG. 1A), and/or other information (e.g., imagery of the environment), the AOAs of peaks newly appearing in or disappearing from the multipath profiles provide clues as to the locations of the objects that moved. If the peaks are associated with LOS paths, for example, their absence (presence) can be used to infer that an object has been placed (removed from) between the corresponding reader/tag pair.

The appearance (or disappearance) of both LOS and NLOS can be used to estimate the missing object's original location more precisely using triangulation. To start, locate each peak that was added to or removed from the multipath profile due to the untagged object movement (308), then estimate the AOA(s) of the newly appearing or disappearing peak(s) (310). The locations of the (possibly untagged) objects that moved can be found by triangulating along these AOAs from one reader to each tag whose multipath profile was affected the movement. In FIGS. 1C and 1D, for example, the peaks 124 in the different traces can be used to estimate (different) AOAs, which in turn can be used to triangulate a projected location of the corresponding tags 120a and 120b (312). Since these peaks correspond to NLOS paths 123, not the LOS paths 121, the projected locations will be different than the tags' actual locations and may fall outside of the room, that is, on the other side of the wall 14, as indicated by the dotted lines at left in FIG. 1C. The paths connecting the reader 110a to the projected locations can be “folded” or reflected off the wall 14 toward to the tags' actual locations to provide an estimate of the corresponding NLOS paths 123 (314). The missing object 12a will have been located at the intersection of two or more of these projected and possibly folded/reflected NLOS paths 123 (316, 318).

### Changes in Vector Representations of Antenna Array Signals

Not every signature collected by the antenna array of an RFID reader features resolvable or distinguishable peaks for NLOS paths. For example, noise or antenna sidelobes may hide or swamp the NLOS peaks. The NLOS peaks may also be too close to the LOS peak to be resolved. Nevertheless, changes in the RFID tag signal detected by the antenna array of an RFID reader can still be used to determine whether or not a nearby object has moved, even if that object does not have an operative RFID tag (or even any RFID tag at all).

To see how, consider the output of an antenna array in an RFID reader that detects a reply from an RFID tag. The output can be represented as a complex vector, with one element in the vector for each antenna element in the antenna array: the output of a four-element array can be represented as a four-element vector, the output of a nine-element array can be represented as a nine-element vector, and so on. Each vector element is a complex representation of the amplitude and phase detected by the corresponding antenna element.

Under normal circumstances, the antenna array detects a baseline or reference response from a given RFID tag. This baseline or reference response can be represented as a baseline or reference vector \vec{r}_{ref}. The reference response might represent the reply of a reference RFID tag mounted on a bare or empty shelf, bin, display rack, garment rack, counter, basket, bucket, cabinet, or other space to a command from the reader (\vec{r}_{empty}). It could also represent the reply of a reference RFID tag mounted on fully stocked shelf to a command from the reader (\vec{r}_{full}). Or it could represent the reply of an RFID tag attached to an item in the environment, e.g., an item that has stayed still long enough to be designated a virtual reference RFID tag.

Moving objects near the RFID tag can change the amplitudes and/or phases of the RFID tag replies collected from the RFID tag by the elements in the antenna array. For example, placing an object between the RFID tag and an antenna element can attenuate the signal; likewise, removing an object from between the RFID tag and the antenna element can reduce path loss and boost the signal amplitude. If the object is (at least partially) transparent to the RFID tag's reply and is moved into or out of the LOS path from the RFID tag to the reader, then moving it may change the path length and the phase of the detect reply. Moving the object may also introduce or remove potentially slight deviations or reflections into the LOS path, possibly turning the LOS path into an NLOS path and changing the path length and the phase of the detected signal.

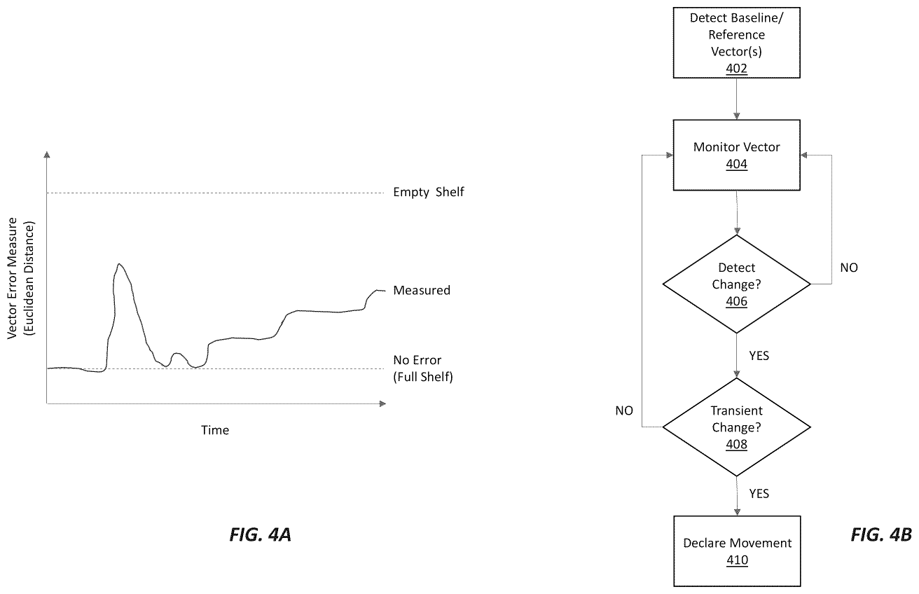

FIGS. 4A and 4B illustrate how changes in the vector representation of an RFID tag's reply as sensed by a reader can be used to infer that a nearby object has moved. FIG. 4A is a plot of the squared Euclidean distance or other error measure, such as the Euclidean distance, between a baseline or reference vector and the vector measured by the antenna array in the reader, \vec{r}ₘₑₐₛ, as a function of time. In this case, the RFID tag is a reference tag on a shelf and the reference vector, \vec{r}_{full}, is for a fully stocked shelf. The squared Euclidean distance can be written as:

d=Σₙ₌₁^{N}(r_{full,i}−r_{meas,i})²,

where N is the number of antenna elements in the antenna array and r_{full(meas),i} is the i^{th} element of the vector \vec{r}_{full(meas)}. If the (squared) Euclidean distance exceeds a predetermined threshold, then the reader may infer that the nearby object has moved.

In FIG. 4A, when the squared Euclidean distance is at a minimum, the shelf is fully stocked (the measured and reference vectors match). When an object is removed from the shelf, the measured vector deviates from the reference vector, resulting in an increase in the error metric. In this case, a peak to the left in FIG. 4A indicates that an item was removed and then replaced. Moving right, the stepped increases in the error metric indicate that successive items are being removed from the shelf without being replaced.

The upper horizontal dashed line at the top of FIG. 4A represents the squared Euclidean distance between a fully stocked shelf and an empty shelf (\vec{r}_{empty}). Thus, the closer the squared Euclidean distance between the measured and reference vectors to the squared Euclidean distance between the fully stocked and empty shelves, the likelier it is that the shelf is empty. The vectors can also be switched, with the vector for the empty shelf serving as the baseline. There are other possible baseline measurements as well, such as partially stocked shelves or shelves stocked with different types of items, in which case the reader may determine the (squared) Euclidean distances from the measured vector to each baseline or reference vector and estimate the shelf's actual condition based on the (squared) Euclidean distances. Generally, the baseline or reference vector corresponding to the shortest (squared) Euclidean distances represent the likeliest condition of the shelf (e.g., fully stocked, partially stocked, stocked with a particular item, or empty).

The duration of a changes in the (squared) Euclidean distance or similar error metric indicates whether the object movement is transient or more permanent. If the change is short—that is, if the Euclidean distance increases, then decreases—this could indicate that someone has taken an untagged item off the shelf, then returned or replaced it. If the change lasts longer, then it could be that someone has removed the item, purchased it, and taken it out of the store. Distinguishing transient from longer lasting changes can be useful when determining whether or not to trigger restocking of the shelves.

FIG. 4B illustrates a process for determining if an item should be restocked based on the change in the vector representation of the signal from a nearby RFID tag. An antenna array in or coupled to an RFID tag reader measures a baseline or reference vector for each possible situation (402) as explained above with respect to FIG. 4A. Then the reader monitors that tag's signature by querying the tag periodically or occasionally, detecting the tag's reply, and calculating an error metric comparing the measured vector for the tag's reply to the baseline/reference vector(s) (404). If the reader detects a change in the error metric (406), it determines whether that change exceeds a predetermined threshold, which may be set high enough to avoid errors caused by measurement noise or slight movements, and if that change lasts longer than a predetermined threshold (e.g., 1 minute, 5 minutes, 10 minutes, 15 minutes, 1 hour, or longer) (408). If there is no change in the error metric, or if the change is short-lived, then the reader continues to monitor the RFID tag's reply vector. Otherwise, the reader declares that an object near the RFID tag has moved (410). This declaration can be used to trigger re-stocking a shelf or other space or another suitable action. For instance, if the reader and RFID tag monitor a changing room, the movement could signal that the changing room is occupied or that items have been left in the changing room and should be returned to the sales floor.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of detecting movement of an item on a shelf, bin, display rack, or garment rack, the method comprising:
detecting a signal from a radio-frequency identification (RFID) tag mounted on or near the shelf, bin, display rack, or garment rack;
performing a comparison of the signal to a previously recorded baseline signal from the RFID tag; and
determining that the item has moved based on the comparison.

2. The method of claim 1, wherein the item is not tagged with an operative RFID tag.

3. The method of claim 1, wherein detecting the signal from the RFID tag comprises detecting, by an antenna array, radiation backscattered from the RFID tag.

4. The method of claim 1, wherein performing the comparison comprises calculating an error metric between a vector representation of the signal and a vector representation of the previously recorded baseline signal.

5. The method of claim 4, wherein determining that the item has moved comprises determining that the error metric exceeds a predetermined threshold.

6. The method of claim 5, wherein determining that the item has moved comprises determining that the error metric exceeds a predetermined threshold for at least a predetermined duration.

7. The method of claim 5, wherein the error metric is a first error metric and the previously recorded baseline signal is a first previously recorded baseline signal representing a first condition of the item, and further comprising:
calculating a second error metric between the vector representation of the signal and a vector representation of a second previously recorded baseline signal representing a second condition of the item;
determining that the first error metric is smaller than the second error metric; and
determining that the item has moved comprises determining that the item is more likely to be in the first condition than the second condition.

8. The method of claim 1, further comprising:
in response to determining that the item has moved, triggering re-stocking of the item.

9. A method of detecting an absence of an item on a shelf, bin, display rack, or garment rack, the method comprising:
detecting a multipath signature of a radio-frequency identification (RFID) tag mounted on or near the shelf, bin, display rack, or garment rack, the multipath signature representing reflection, scattering, and/or attenuation, by the item, of radiation backscattered from the RFID tag in response to an interrogation signal from a reader;
detecting a change in the multipath signature of the RFID tag caused by moving the item with respect to the RFID tag; and
determining that the item has been moved based on the change in the multipath signature of the RFID tag.

10. The method of claim 9, wherein the item is not tagged with an RFID tag.

11. The method of claim 9, wherein detecting the multipath signature of the RFID tag comprises detecting, by the reader, the radiation backscattered from the RFID tag along at least one non-line-of-sight path from the RFID tag and the reader.

12. The method of claim 11, wherein detecting the change in the multipath signature of the RFID tag comprises sensing a change in power received by the reader from the RFID tag.

13. The method of claim 11, wherein detecting the change in the multipath signature of the RFID tag comprises sensing a change in power propagating along the at least one non-line-of-sight path from the RFID tag and the reader.

14. The method of claim 9, wherein determining that the item has been moved comprises determining that the item has been removed from the shelf, bin, display rack, or garment rack.

15. The method of claim 14, further comprising:
in response to determining that the item has been removed from the shelf, bin, display rack, or garment rack, replacing the item on the shelf, bin, display rack, or garment rack.

16. The method of claim 9, further comprising:
determining that the RFID tag has not moved with respect to the reader based on positions of at least two peaks in the multipath signature of the RFID tag.

17. The method of claim 9, wherein the reader is a first reader and the multipath signature is a first multipath signature, and further comprising:
detecting a second multipath signature of the RFID tag at a second reader; and
determining that the RFID tag has not moved with respect to the first reader based on the first multipath signature and the second multipath signature.

18. The method of claim 9, further comprising, before detecting the change in the multipath signature:
determining that the RFID tag is stationary based on the multipath signature; and
in response to determining that the RFID tag is stationary, designating the RFID tag as a virtual reference tag.

19. A method of detecting movement of an object from a nominal location of the object, the method comprising:
detecting a multipath signature of a radio-frequency identification (RFID) tag mounted on a fixed object near the nominal location of the object, the multipath signature representing reflection, scattering, and/or attenuation, by the object, of radiation backscattered from the RFID tag in response to an interrogation signal from a reader;
moving the object with respect to the fixed object;
detecting a change in the multipath signature of the RFID tag caused by moving the object with respect to the fixed object; and
determining that the object has been moved based on the change in the multipath signature of the RFID tag.
